(19) United States
(12) Patent Application Publication
(10) Pub. No.: US 2025/0162546 A1
(43) Pub. Date: May 22, 2025

(54) Mobile Changing Unit for Inserting a Battery Module

(71) Applicant: Jörg Salomon, Bonn (DE)

(72) Inventor: Jörg Salomon, Bonn (DE)

(73) Assignee: Deutsche Post AG, Bonn (DE)

(21) Appl. No.: 18/950,322

(22) Filed: Nov. 18, 2024

(30) Foreign Application Priority Data
Nov. 20, 2023 (DE) 10 2023 132 228.1

(51) Int. Cl. B60S 5/06; B60L 53/80; B66F 9/065; H01M 50/249

(52) U.S. Cl. CPC B60S 5/06; B66F 9/065; H01M 50/249; B60L 53/80

(57) ABSTRACT

An apparatus including means configured to navigate a mobile changing unit to a first position beneath a vehicle. The means configured to determine at least one insertion apparatus of the mobile changing unit. The at least one insertion apparatus is configured to insert a battery module placed on the insertion apparatus into the vehicle. The means configured to cause insertion of the battery module placed on the determined at least one insertion apparatus into the vehicle. The apparatus is part of the mobile changing unit. The means are further configured to obtain vehicle information. The vehicle information represents the vehicle. Determining the at least one insertion apparatus is at least partially based on the obtained vehicle information.

### CROSS-REFERENCE TO RELATED PATENT APPLICATIONS

This patent application claims the benefit of priority to German Patent Application No. 102023132228.1, filed Nov. 20, 2023, the entire teachings and disclosures are incorporated herein by reference thereto.

### TECHNICAL FIELD

Illustrative embodiments of the present disclosure relate to an apparatus, a method, a computer program and a system for inserting at least one battery module into a vehicle.

### BACKGROUND

In the field of electromobility, for example, vehicles that are driven at least in part by an electric motor have one or more rechargeable battery modules. Such battery modules normally have to be regularly charged in order for the electric drive of the vehicle to continue to be able to be utilized. This can involve the use of electric charging stations, for example, the practical use of which entails various disadvantages, however. For example, electric charging stations are permanently installed at a respective location, which means that vehicles can utilize these charging stations to charge their battery modules only in a manner tied to the locality. Moreover, installing an electric charging station is normally associated with great effort.

An alternative concept provides for a drained battery module of a vehicle not to be charged at an electric charging station, but rather to be exchanged for a charged battery module at a battery exchange station. Such battery exchange stations are normally also permanently installed at a specific location, however, and can therefore afford only limited flexibility.

### SUMMARY OF ILLUSTRATIVE EMBODIMENTS OF THE PRESENT DISCLOSURE

The present disclosure is therefore based on the object, inter alia, of simplifying the provision of battery modules for vehicles.

In accordance with the present disclosure, an apparatus is disclosed, wherein the apparatus comprises means, and wherein the means are configured to:
navigate a mobile changing unit to a first position beneath a vehicle;
determine at least one insertion apparatus of the mobile changing unit, wherein the at least one insertion apparatus is configured to insert a battery module placed on the insertion apparatus into the vehicle; and
cause insertion of the battery module placed on the determined at least one insertion apparatus into the vehicle.

In accordance with the present disclosure, a method is further disclosed, wherein the method comprises the following steps:
navigating a mobile changing unit to a first position beneath a vehicle;
determining at least one insertion apparatus of the mobile changing unit, wherein the at least one insertion apparatus is configured to insert a battery module placed on the insertion apparatus into the vehicle; and
causing insertion of the battery module placed on the determined at least one insertion apparatus into the vehicle.

For example, the apparatus in accordance with the present disclosure is configured to perform and/or control the method in accordance with the present disclosure, or the apparatus in accordance with the present disclosure comprises respective means for performing and/or performing the method in accordance with the present disclosure. Either all of the steps of the method can be controlled, or all of the steps of the method can be performed, or one or more steps can be controlled and one or more steps can be performed. By way of example, one or more of the means may be formed by one or more processors.

In another example, the apparatus in accordance with the present disclosure is an apparatus that comprises at least one processor and at least one memory containing program code, wherein the memory and the program code are configured to cause an apparatus having the at least one processor to perform and/or control at least the method in accordance with the present disclosure. Either all of the steps of the method can be controlled, or all of the steps of the method can be performed, or one or more steps can be controlled and one or more steps can be performed.

In accordance with the present disclosure, a computer program is further disclosed, the computer program comprising commands that cause an apparatus to perform the steps of the method in accordance with the present disclosure. This may be the apparatus in accordance with the present disclosure, for example. In another example, the computer program comprises program instructions that cause a processor to perform and/or control the method in accordance with the present disclosure when the computer program runs on the processor. A processor is intended to be understood to mean, inter alia, control units, microprocessors, microcontrol units such as microcontrollers, digital signal processors (DSPs), application-specific integrated circuits (ASICs) or field programmable gate arrays (FPGAs). Either all of the steps of the method can be controlled, or all of the steps of the method can be performed, or one or more steps can be controlled and one or more steps can be performed. By way of example, the computer program may be distributable via a network such as the Internet, a telephone or mobile radio network and/or a local area network. At least part of the computer program may be software and/or firmware of a processor. At least part may equally be implemented as hardware. By way of example, the computer program may be stored on a computer-readable storage medium, for example a magnetic, electrical, optical and/or other kind of storage medium. By way of example, the storage medium may be part of the processor, for example a (nonvolatile or volatile) program memory of the processor or a portion thereof. By way of example, the storage medium may be a substantive or physical storage medium.

For example, the mobile changing unit can be understood to mean a vehicle (e.g. a transport vehicle) that can advance autonomously, at least in part, and can transport one or more battery modules. By way of example, the mobile changing unit is an unmanned vehicle (e.g. an unmanned transport vehicle). For example, the mobile changing unit can be understood to mean a mobile robot or a mobile robot system. By way of example, the mobile changing unit can have as low a height as possible, and so it can move beneath another vehicle (e.g. an automobile or a truck).

The apparatus in accordance with the present disclosure may be a part of the mobile changing unit and can be understood to mean, for example, a control apparatus of the mobile changing unit that is connected to individual components of the mobile changing unit. In another example, the apparatus in accordance with the present disclosure can correspond to the mobile changing unit and comprise all individual components of the mobile changing unit.

As described later on, the mobile changing unit comprises at least one insertion apparatus on which, by way of example, a battery module to be transported by the mobile changing unit can be placed. The mobile changing unit can comprise a single insertion apparatus or multiple insertion apparatuses, which are arranged beside one another (e.g. at the same height) as part of the mobile changing unit, for example.

To allow the mobile changing unit to advance, the mobile changing unit can comprise one or more moving means. The moving means comprise, for example, a motor drive (e.g. an electrical motor drive), a plurality of wheels (e.g. omnidirectional wheels or differential wheels) or chains (e.g. a caterpillar track) and steering means (e.g. a steering mechanism for steering the wheels). For example, the mobile changing unit further comprises a control apparatus that electrically actuates the individual components of the mobile changing unit (e.g. the insertion apparatus or the moving means) and can therefore control the movement of the mobile changing unit in order to navigate the mobile changing unit.

Navigating the mobile changing unit to a first position can be understood to mean, by way of example, that a control apparatus of the mobile changing unit actuates the moving means (e.g. a motor drive and steering means) of the mobile changing unit in such a way that the mobile changing unit moves from a present position to the first position. For example, at least part of the mobile changing unit moves by remote control or in an autonomously driving manner to the first position, for example using sensors such as cameras, ultrasonic sensors or infrared sensors to detect and avoid obstacles on the path to the first position. Alternatively or additionally, the mobile changing unit can use locating sensors (e.g. one or more GPS sensors), for example, to navigate the mobile changing unit to the first position.

The first position is beneath a vehicle and the mobile changing unit is, for example, in sufficiently shallow form for it to be able to move beneath the vehicle. For example, the vehicle is a vehicle in which one or more battery modules are intended to be replaced. In particular, a battery module transported by the mobile changing unit is meant to be inserted into the vehicle, for example, in order to replace a previously drained battery module of the vehicle. The vehicle is, for example, an automobile or a truck and is additionally electrically driven, at least in part. For example, the vehicle may be a vehicle driven entirely by electrical battery, a plug-in hybrid vehicle or a hybrid vehicle.

The first position beneath the vehicle is, for example, beneath a battery module compartment in the underbody of the vehicle, so that, when the mobile changing unit is in the first position, a battery module placed on an insertion apparatus of the mobile changing unit can be inserted into the vehicle (e.g. into a battery module compartment provided for this purpose). The first position beneath the vehicle is defined by GPS coordinates, for example, which are utilized by the mobile changing unit to navigate to the first position. In another example, the first position beneath a vehicle is defined with reference to the vehicle (e.g. by a predetermined distance from the vehicle or from a battery module compartment of the vehicle). By way of example, one or more reference markers on the vehicle can be used as a reference point with reference to the vehicle, in order to define the first position with reference to the vehicle (e.g. in order to permit particularly accurate positioning of the mobile changing unit).

Determination of at least one insertion apparatus of the mobile changing unit can be understood to mean, for example, selection of an insertion apparatus. For example, the mobile changing unit comprises a plurality of insertion apparatuses, determination of an insertion apparatus comprising, for example, selecting one insertion apparatus from the plurality of insertion apparatuses of the mobile changing unit. By way of example, the insertion apparatus is determined in a predetermined order (e.g. an order in which all insertion apparatuses of the mobile changing unit are intended to be selected in succession). In another example, the insertion apparatus is determined according to a battery module placed on the insertion apparatus. By way of example, information that denotes a battery module to be inserted into the vehicle is taken as a basis for determining a corresponding insertion apparatus on which the denoted battery module is placed. For this purpose, an electronic memory of the apparatus stores, for example, information about which respective battery module is placed on which insertion apparatus from a possible plurality of insertion apparatuses of the mobile changing unit.

In another example, determination of at least one insertion apparatus can be based on battery module information. By way of example, such battery module information can indicate which battery module is placed on which insertion apparatus of the mobile changing unit. Additionally or alternatively, battery module information can denote a battery module that is intended to be inserted into the vehicle.

In another example, determination of at least one insertion apparatus can be based on vehicle information, the vehicle information denoting, for example, the vehicle that the mobile changing unit in the first position is under and into which a battery module placed on an insertion apparatus of the mobile changing unit is intended to be inserted.

The mobile changing unit has at least one insertion apparatus, wherein such an insertion apparatus is configured to insert a battery module placed on the insertion apparatus into the vehicle beneath which the mobile changing unit is in the first position. For example, the insertion apparatus is configured to raise a battery module placed on the insertion apparatus and thus to insert said battery module into the vehicle. Accordingly, the insertion apparatus can be understood to mean a lifting apparatus, for example.

For example, an insertion apparatus of the mobile changing unit comprises a platform on which a battery module can be placed. Moreover, the insertion apparatus comprises, for example, a lifting mechanism that is configured to raise the platform and a battery module placed thereon. By way of example, such a lifting mechanism can comprise a hydraulic system, an electric motor, a scissor mechanism, a telescopic boom and/or further mechanisms.

Inserting the battery module into the vehicle comprises, for example, inserting the battery module into a battery module compartment in the underbody of the vehicle. As part of the insertion or subsequent to the insertion of the battery module into the vehicle, the battery module can be, for example, fastened (e.g. fixed) in the vehicle, for example by virtue of the battery module sliding into a retaining apparatus (which e.g. comprises a locking mechanism) of the vehicle and being held there.

For example, the battery module to be inserted is a charged battery module that replaces a previously drained battery module in the vehicle. By way of example, such a drained battery module is removed from the vehicle before the battery module placed on the insertion apparatus is inserted into the vehicle. For this purpose, the mobile changing unit can have at least one removal apparatus, for example.

By way of example, a battery module can be understood to mean part of a battery stack (e.g. a stack of batteries). For example, a single battery module can contain one or more battery cells (e.g. lithium ion battery cells) that provide the drive motor of the vehicle with electrical energy, for example.

For example, causing insertion of the battery module placed on the determined at least one insertion apparatus into the vehicle comprises the insertion apparatus determined in the previous step being actuated by the apparatus so that for example a lifting mechanism of this determined insertion apparatus is activated and thus this lifting mechanism is caused to raise the battery module placed on the platform of the insertion apparatus and to insert said battery module into the vehicle.

In one example, in which more than one insertion apparatus of the mobile changing unit has been determined in a previous step, for example each of the determined insertion apparatuses in succession is caused to insert the battery module placed on the respective insertion apparatus into the vehicle.

Advantageously, the apparatus in accordance with the present disclosure thus permits one or more battery modules to be advantageously inserted into a vehicle and, for example, previously drained battery modules to be replaced without being reliant on a permanently installed battery exchange station. Instead, the mobile changing unit is utilized, which can move under the relevant vehicle. Advantageously, the relevant vehicle can be parked, for example in a conventional parking space (e.g. a public car park), for the period of the battery exchange. The relevant vehicle does not have to be parked, in particular for the exchange operation, in a parking space permanently installed for this purpose at a battery exchange station and moved on from a permanently installed parking space such as this after the exchange operation.

If for example the vehicle is a truck, this truck does not need to be moved in order to replace a battery module, and so possible resting times of the driver of the truck are advantageously not disrupted. If the mobile changing unit performs multiple battery exchange operations for multiple trucks, for example, these trucks can advantageously be parked in conventional parking spaces and for example at a normally customary distance from one another. This saves space, compared with the use of permanently installed battery exchange stations or permanently installed electric charging stations, as a result of the use of the mobile changing unit. Such battery replacement on multiple trucks advantageously requires just a single mobile changing unit. By contrast, the use of conventional charging stations or battery exchange stations would require a plurality of stations in order to avoid moving the trucks before and after charging/exchange of the battery modules. The effort for installing conventional stations such as these is advantageously avoided by using the mobile changing unit.

Further advantages of the illustrative aspects of the present disclosure are described hereinbelow on the basis of illustrative embodiments, the disclosure of which is intended to apply to the apparatus, the method and the computer program of the present disclosure in equal measure.

In an illustrative embodiment in accordance with the present disclosure, the mobile changing unit comprises a plurality of insertion apparatuses including the at least one insertion apparatus, wherein each of the insertion apparatuses is configured to insert a battery module placed on the respective insertion apparatus, and wherein the means of the apparatus in accordance with the present disclosure are further configured to:
determine at least one further insertion apparatus from the plurality of insertion apparatuses; and
cause insertion of a further battery module placed on the determined at least one further insertion apparatus into the vehicle.

For example, as described above, it is possible not only for at least one insertion apparatus to be determined but also for at least one further insertion apparatus to be determined. Accordingly, for example a first insertion apparatus, a second insertion apparatus and also further insertion apparatuses can be determined. As described above for determination of the at least one insertion apparatus, determination of the at least one further insertion apparatus may also be based on one or more pieces of information (e.g. on battery module information or vehicle information).

The insertion apparatuses from the plurality of insertion apparatuses of the mobile changing unit are arranged for example behind one another and/or beside one another on the mobile changing unit, the insertion apparatuses being in an arrangement for example in one plane on the mobile changing unit. For example, the mobile changing unit comprises two, four, six or, additionally, further insertion apparatuses on which respective battery modules can be placed. By way of example, the battery modules placed on the respective insertion apparatuses are all intended to be inserted into a determined vehicle. In another example, the battery modules placed on the respective insertion apparatuses are intended for multiple vehicles, these multiple vehicles being approached in succession by the mobile changing unit in order to insert the applicable battery modules.

For example, causing insertion of the battery module placed on the determined at least one further insertion apparatus into the vehicle comprises actuating the one further insertion apparatus determined in the previous step so that, for example, a lifting mechanism of this determined further insertion apparatus is activated and thus this lifting mechanism is caused to raise the battery module placed on the platform of the further insertion apparatus and to insert said battery module into the vehicle.

Since multiple battery modules are individually inserted into the vehicle by multiple respective insertion apparatuses, the mobile changing unit can advantageously have as low a height as possible and nevertheless transport a plurality of battery modules. Accordingly, the mobile changing unit can move beneath another vehicle (e.g. an automobile or a truck) even if it is transporting a plurality of battery modules.

In one illustrative embodiment, the means of the apparatus in accordance with the present disclosure are further configured to:
navigate the mobile changing unit, after the at least one battery module has been inserted into the vehicle and before the at least one further battery module is inserted into the vehicle, from the first position to a second position beneath the vehicle.

For example, the mobile changing unit is in front of the vehicle and, during insertion of the at least one battery module, in the first position beneath the vehicle, and so the determined at least one insertion apparatus is under a battery module compartment in the underbody of the vehicle. When for example the mobile changing unit is in the first position, the battery module placed on the at least one insertion apparatus of the mobile changing unit can be inserted into the battery module compartment by raising the platform of the insertion apparatus.

After such insertion of the at least one battery module, the mobile changing unit can be navigated to a second position beneath the vehicle before the at least one further battery module is inserted into the vehicle. By way of example, this second position is chosen such that the determined at least one further insertion apparatus is under a battery module compartment in the underbody of the vehicle. When for example the mobile changing unit is in the second position, the further battery module placed on the at least one further insertion apparatus of the mobile changing unit can be inserted into the battery module compartment by raising the platform of the further insertion apparatus. By way of example, the further battery module is thus inserted inside the battery module compartment beneath the previously inserted at least one battery module.

Like the first position, the second position may be defined by GPS coordinates, for example, which are utilized by the mobile changing unit to navigate to the second position. In another example, the second position beneath a vehicle is defined with reference to the vehicle (e.g. by a predetermined distance from the vehicle or from a battery module compartment of the vehicle). By way of example, one or more reference markers on the vehicle can be used as a reference point with reference to the vehicle, in order to define the second position with reference to the vehicle (e.g. in order to permit particularly accurate positioning of the mobile changing unit).

Advantageously, navigating the mobile changing unit from the first to the second position between inserting the at least one battery module and the further battery module allows the two battery modules to be inserted into the vehicle in such a way that they are arranged beneath one another (e.g. in the form of a battery stack) inside a battery module compartment of the vehicle. The battery modules arranged above one another in such a way are advantageously on different insertion apparatuses while being transported by the mobile changing unit, however, which means that the total height of the loaded mobile changing unit can be reduced and movement beneath the vehicle can be permitted.

In one illustrative embodiment, the means of the apparatus in accordance with the present disclosure are further configured to:
cause, after the at least one battery module has been inserted, insertion of at least one further battery module placed on the determined at least one insertion apparatus into the vehicle.

For example, the mobile changing unit is in the first position beneath a battery module compartment of the vehicle when the at least one battery module is inserted and also when the one further battery module is inserted, and so the further battery module is thus inserted inside the battery module compartment beneath the previously inserted at least one battery module. For example, after the at least one battery module has been inserted, the at least one insertion apparatus is reloaded with the one further battery module before the further battery module is inserted into the vehicle by the at least one insertion apparatus. By way of example, the mobile changing unit is to this end navigated, after the at least one battery module has been inserted, to a battery module station at which the mobile changing unit is loaded with the further battery module, in particular on the same insertion apparatus as that on which the previously inserted battery module was placed. For example, the mobile changing unit is then navigated back to the first position beneath the vehicle before the one further battery module is inserted into the vehicle. By way of example, the further battery module is thus inserted inside a battery module compartment beneath the previously inserted at least one battery module.

Since multiple battery modules are, in particular individually, inserted into the vehicle by the same insertion apparatus, the mobile changing unit can advantageously have as low a height as possible, as only a single battery module is placed on the applicable insertion apparatus in each case. Accordingly, the mobile changing unit can move beneath another vehicle (e.g. an automobile or a truck), for example, even if all in all it is transporting a plurality of battery modules and inserting them into the vehicle. Advantageously, this merely requires the mobile changing unit to have only one insertion apparatus, for example. Furthermore, since the mobile changing unit is in the first position beneath the vehicle when the at least one battery module and the one further battery module are inserted, for example, the two battery modules can be inserted into the vehicle in such a way that they are arranged beneath one another (e.g. in the form of a battery stack) inside a battery module compartment of the vehicle.

In an illustrative embodiment in accordance with the present disclosure, the at least one insertion apparatus and/or the plurality of insertion apparatuses of the mobile changing unit are configured to insert the at least one battery module and the at least one further battery module into the vehicle in such a way that the at least one battery module and the at least one further battery module form a single battery stack inside the vehicle.

For example, a battery stack (e.g. a stack of batteries) can be understood to mean at least two battery modules arranged beneath one another, these battery modules arranged beneath one another being electrically connected to one another, for example. By way of example, such a battery stack can be formed inside the vehicle (e.g. in a battery module compartment of the vehicle) by first inserting the at least one battery module into the vehicle and then inserting the at least one further battery module beneath the at least one battery module.

Advantageously, a battery stack formed by multiple single battery modules can be used to cover various power requirements of a vehicle. For example, just one battery module suffices to operate the vehicle, and additional battery modules of a battery stack can moreover provide the vehicle with additional electrical energy, and so for example the range of the vehicle is increased.

In an illustrative embodiment in accordance with the present disclosure, the at least one battery module and the at least one further battery module are arranged beneath one another and/or electrically connected to one another within the battery stack.

For example, the at least one battery module and the at least one further battery module are electrically connected to one another as a result of being electrically connected to one another in series or parallel (e.g. to achieve a desired voltage or electrical capacitance). An electrical connection between the two battery modules can be achieved for example by way of additional connecting structures of the battery modules, which physically connect the battery modules to one another and ensure electrical contact between the battery modules. By way of example, the vehicle into which the battery modules are inserted can comprise a battery management system that monitors the state of the battery modules and controls the discharge process, for example.

In an illustrative embodiment, the means of the apparatus in accordance with the present disclosure are further configured to:
cause removal of a battery module from the vehicle before the at least one and/or the at least one further battery module is inserted into the vehicle, wherein the mobile changing unit comprises at least one removal apparatus for removing a battery module from the vehicle.

For example, a removal apparatus is designed like an insertion apparatus, and so for example an insertion apparatus of a mobile changing unit can simultaneously be used as a removal apparatus of the mobile changing unit, or vice versa. For example, a removal apparatus of the mobile changing unit comprises a platform on which a battery module can be placed. Moreover, the removal apparatus comprises a lifting mechanism, for example, which is configured to lower the platform and a battery module placed thereon. By way of example, such a lifting mechanism can comprise a hydraulic system, an electric motor, a scissor mechanism, a telescopic boom and/or further mechanisms.

Removing the battery module from the vehicle comprises removing the battery module from a battery module compartment in the underbody of the vehicle, for example. As part of the removal or before the removal of the battery module from the vehicle, the battery module can, by way of example, be released in the vehicle (e.g. released from a fastening in the vehicle), for example by removing the battery module from a retaining apparatus (e.g. comprising a locking mechanism) of the vehicle.

For example, the battery module to be inserted is a drained battery module in the vehicle, which is replaced by a charged battery module. By way of example, a drained battery module such as this is removed from the vehicle before the battery module placed on an insertion apparatus is inserted into the vehicle.

Before removal is caused, the mobile changing unit is navigated to a removal position beneath the vehicle, for example, and so a battery module is removed while the mobile changing unit is in the removal position.

In an illustrative embodiment, the means of the apparatus in accordance with the present disclosure are further configured to:
obtain at least one battery module information, wherein the battery module information represents a battery module, and wherein determining the at least one insertion apparatus is at least partially based on the obtained battery module information.

The battery module information can be understood to mean electronic information coded (e.g. binary-coded) in electronic form, for example. In particular, the battery module information can be obtained by transmitting it from other means (e.g. communication means or sensor means) to the means of the apparatus.

For example, the battery module information represents a battery module by containing an identifier of the battery module, such an identifier (e.g. a label or an address) of the battery module uniquely identifying the battery module. By way of example, the battery module represented by battery module information is determinable (e.g. identifiable) on the basis of this battery module information. In addition to the representation of a battery module, the battery module information can indicate further information (e.g. further parameters).

In one example, the obtained battery module information represents (e.g. identifies or denotes) a battery module that is intended to be inserted into the vehicle. By way of example, the mobile changing unit comprises a plurality of insertion apparatuses on which respective battery modules are placed. Obtained battery module information then represents for example a determined battery module, which is intended to be inserted into the vehicle, from the plurality of battery modules. In such an example, the battery modules placed on the other insertion apparatuses may be intended for another vehicle, for example, and therefore inserted into this other vehicle at a later time.

Determination of the at least one insertion apparatus is based at least in part on the obtained battery module information. If for example the battery module information represents a battery module that is intended to be inserted into the vehicle, the insertion apparatus on which the battery module represented by the battery module information is placed is determined on the basis of the battery module information, for example. In such an example, determination of the insertion apparatus may additionally be based on information (e.g. stored in an electronic memory of the apparatus) that indicates for the plurality of insertion apparatuses of the mobile changing unit which battery module, if any, is placed on the respective insertion apparatus.

Advantageously, the battery module information can be taken as a basis for specifically selecting a determined battery module, which can then be inserted into the vehicle. When a plurality of battery modules are being transported on the mobile changing unit, the battery modules placed on the various insertion apparatuses do not necessarily have to be inserted in a predetermined order, but rather can be inserted under the specific control (e.g. remote control) of the battery module information, for example.

In another example, the obtained battery module information represents (e.g. identifies or denotes) a battery module that is placed on a determined insertion apparatus. In such an example, the battery module information can represent an identifier (e.g. a label or an address) of the battery module, for example, and can additionally (e.g. at least implicitly) represent an identifier (e.g. a label or an address) of the insertion apparatus on which the battery module is placed. In addition to such battery module information, information may be available (which e.g. is stored in an electronic memory of the apparatus) that denotes a determined battery module that is intended to be inserted into the vehicle. By way of example, the battery module information then indicates that insertion apparatus of the mobile changing unit on which the battery module intended to be inserted into the vehicle is placed, and so this insertion apparatus can be determined on the basis of the battery module information.

Advantageously, the apparatus can accordingly use the battery module information to detect, for example for a plurality of insertion apparatuses of the mobile changing unit, which battery module, if any, is placed on a respective insertion apparatus.

In an illustrative embodiment, the apparatus in accordance with the present disclosure further comprises sensor means configured to obtain the battery module information from the battery module represented by the battery module information.

For example, battery module information is represented by an optically capturable code (e.g. a barcode or a QR code) that is applied to the battery module (e.g. printed on a housing of the battery module). The sensor means of the apparatus can then comprise, by way of example, a code scanner (e.g. an optical sensor such as a camera) that scans the optically capturable code from the battery module. In another example, the sensors can comprise an electronic receiver that receives, by way of example, the battery module information in the form of an electrical signal from the battery module by means of short-range radio communication (e.g. Bluetooth, NFC or RFID). For example, the battery module is then equipped with an electrical transmitter that transmits the battery module information, so that it can be received by the sensor means of the mobile changing unit.

By way of example, the sensor means are each arranged on or at least close to a respective insertion apparatus of the mobile changing unit. For example, each platform of an insertion apparatus on which an applicable battery module can be placed holds a code scanner or an electrical receiver as part of the sensor means. Should a battery module be placed on a determined insertion apparatus, the optically capturable code applied to this battery module is scanned by a code scanner arranged on the platform of the insertion apparatus, for example, and is relayed to the apparatus as battery module information. By way of example, the apparatus stores information about which code scanner is arranged on which platform of the respective insertion apparatus. Since the battery module information is received on the apparatus from a specific code scanner, the battery module information additionally indicates (e.g. at least implicitly) the insertion apparatus on which the battery module represented by the battery module information is placed.

In an illustrative embodiment, the apparatus in accordance with the present disclosure further comprises communication means configured to receive the battery module information from a backend server.

For example, the battery module information is received by communication means of the apparatus via a wireless communication network. By way of example, the communication means of the apparatus then comprise a mobile radio interface that can receive the battery module information from the backend server via a mobile radio network. By way of example, the backend server can be understood to mean a management server that is used to ascertain which battery module is intended to be inserted and/or removed in which vehicle by a mobile changing unit (e.g. from a plurality of mobile changing units). Battery module information transmitted from the backend server to the apparatus accordingly represents, by way of example, a battery module that has previously been ascertained by the backend server and that is intended to be inserted into the vehicle.

In an illustrative embodiment, the means of the apparatus in accordance with the present disclosure are further configured to:
obtain vehicle information, wherein the vehicle information represents the vehicle, and wherein determining the at least one insertion apparatus is at least partially based on the obtained vehicle information.

The vehicle information can be understood to mean electronic information coded (e.g. binary-coded) in electronic form, for example. In particular, the vehicle information can be obtained by transmitting it from other means (e.g. communication means or sensor means) to the means of the apparatus. For example, the vehicle information is transmitted from a backend server or from the vehicle represented by the vehicle information to the apparatus.

For example, the vehicle information represents a vehicle by containing an identifier of the vehicle, such an identifier (e.g. a label or an address) of the vehicle uniquely identifying the vehicle. By way of example, the vehicle represented by vehicle information is determinable (e.g. identifiable) on the basis of this vehicle information. In addition to the representation of a vehicle, the vehicle information can indicate further information (e.g. further parameters).

In particular, the vehicle information represents the vehicle that has the first position beneath it and into which the apparatus inserts at least one battery module after the at least one insertion apparatus has been determined. By way of example, the vehicle information is obtained together with position information (e.g. received jointly from a backend server) that indicates the first position and that is utilized to navigate the mobile changing unit to the first position. In another example, the vehicle information is obtained after navigation or during navigation to the first position.

By way of example, the at least one insertion apparatus is determined at least in part on the basis of the vehicle information. For example, the mobile changing unit transports a plurality of battery modules, these being intended for different vehicles. If the apparatus then obtains vehicle information, for example, that represents a vehicle, the apparatus can ascertain which of the transported battery modules is intended for this vehicle and is to be inserted into this vehicle. The apparatus can then ascertain (e.g. on the basis of battery module information) on which insertion apparatus a battery model to be inserted is placed and can thus determine the at least one insertion apparatus. Determination of the at least one insertion apparatus may for example additionally be based on obtained battery module information, for example if this additional battery module information indicates a battery module that is intended to be inserted into a specific vehicle (e.g. into the vehicle represented by the vehicle information).

Advantageously, the apparatus can take the obtained vehicle information as a basis for identifying a specific vehicle into which a battery module is intended to be inserted. This is useful for example if the mobile changing unit heads for multiple vehicles in succession and accordingly transports a multiplicity of battery modules, each of the battery modules being intended for different vehicles. Based on the vehicle information, the apparatus can, in such cases, for example identify which vehicle is concerned by an imminent insertion of a battery module and can thus ascertain the applicable battery module for this vehicle.

In an illustrative embodiment, the apparatus in accordance with the present disclosure further comprises communication means configured to receive the vehicle information from the vehicle or from a backend server.

For example, the vehicle information is received from the vehicle by the communication means of the apparatus by means of short-range radio communication (e.g Bluetooth, NFC or RFID), wherein the vehicle information represents this vehicle. In this case, the communication means of the apparatus comprise for example a short-range radio communication interface for receiving the vehicle information, and the vehicle information is transmitted by a corresponding short-range radio communication interface of the vehicle.

By way of example, the vehicle information transmitted by the vehicle is receivable only in a spatially limited area around the vehicle, and so the apparatus receives the vehicle information for example only when the mobile changing unit is nearing the vehicle (e.g. while the mobile changing unit is being navigated to the first position beneath the vehicle). Advantageously, the apparatus can then take the vehicle information received from the vehicle, for example, as a basis for identifying which vehicle the mobile changing unit is nearing and on which vehicle the next insertion of a battery module is pending. Based on the received vehicle information, a battery module to be inserted and an applicable insertion apparatus can then be determined, for example.

In another example, the vehicle information is received by communication means of the apparatus via a wireless communication network. By way of example, the communication means of the apparatus then comprise a mobile radio interface that can receive the vehicle information from the backend server via a mobile radio network. By way of example, the backend server can be understood to mean a management server that is used to ascertain in which vehicle which battery module is intended to be inserted and/or removed by a mobile changing unit (e.g. from a plurality of mobile changing units). Vehicle information transmitted from the backend server to the apparatus accordingly represents, by way of example, a vehicle that has previously been ascertained by the backend server and into which a battery module is intended to be inserted next. Advantageously, the received vehicle information can be utilized to determine an insertion apparatus, in particular if the mobile changing unit is transporting a plurality of battery modules at the same time and therefore travelling along multiple vehicles in succession in order to insert the battery modules into vehicles ascertained by the backend server.

In an illustrative embodiment, the apparatus in accordance with the present disclosure further comprises:
moving means for moving the mobile changing unit comprising a motor drive and/or a plurality of wheels; and/or
the at least one insertion apparatus; and/or
the at least one removal apparatus; and/or
communication means for communicating with the backend server and/or the vehicle.

The apparatus in accordance with the present disclosure may be a part of the mobile changing unit and can be understood to mean, for example, a control apparatus of the mobile changing unit that is connected to individual components and different means of the mobile changing unit. Moreover, the apparatus can comprise at least some means or all means of the mobile changing unit. As such, the apparatus can comprise for example not only a control apparatus of the mobile changing unit but also moving means (e.g. a motor drive and/or a plurality of wheels), insertion apparatus(es), removal apparatus(es) and/or communication means (e.g. a short-range radio communication interface and/or a mobile radio interface) of the mobile changing unit. For example, the apparatus can comprise all means of the mobile changing unit and thus can correspond to the mobile changing unit, for example.

Further, the present disclosure discloses a system that comprises at least the apparatus in accordance with the present disclosure and the mobile changing unit, the system further being able to comprise the vehicle and/or the backend server, for example. Should the apparatus in accordance with the present disclosure correspond to the mobile changing unit, for example, the disclosed system comprises at least the apparatus and also the vehicle and/or the backend server.

The exemplary embodiments and exemplary configurations of the present disclosure that are described above should also be understood as disclosed in all combinations with one another. In particular, the disclosure of a method step is also deemed to be disclosure of means for performing the respective method step. Likewise, the disclosure of means for performing a method step is also deemed to be disclosure of the method step itself.

Further advantageous illustrative configurations of the present disclosure can be gathered from the following detailed description of some exemplary embodiments in particular in association with the figures. The accompanying figures are, however, only intended for the purpose of elucidation, but do not serve to determine the scope of protection of the claims. The accompanying drawings are not necessarily true to scale and are intended to reflect only the general concept of the present disclosure by way of illustration. In particular, features which are included in the figures are in no way intended to be considered a necessary part of the present invention.

### BRIEF DESCRIPTION OF THE DRAWINGS

In the drawings:

FIGS. 1a and 1b show schematic representations of an illustrative embodiment in accordance with the present disclosure;

FIG. 2 shows a schematic representation of an illustrative embodiment of sensor means in accordance with the present disclosure;

FIGS. 3a, 3b and 3c show schematic representations of a further illustrative embodiment in accordance with the present disclosure;

FIG. 4 shows a flowchart for an illustrative embodiment of the method in accordance with the present disclosure;

FIG. 5 shows a schematic representation of an illustrative embodiment of the apparatus in accordance with the present disclosure; and

FIG. 6 shows illustrative embodiments of storage media.

### DETAILED DESCRIPTION OF SOME ILLUSTRATIVE EMBODIMENTS

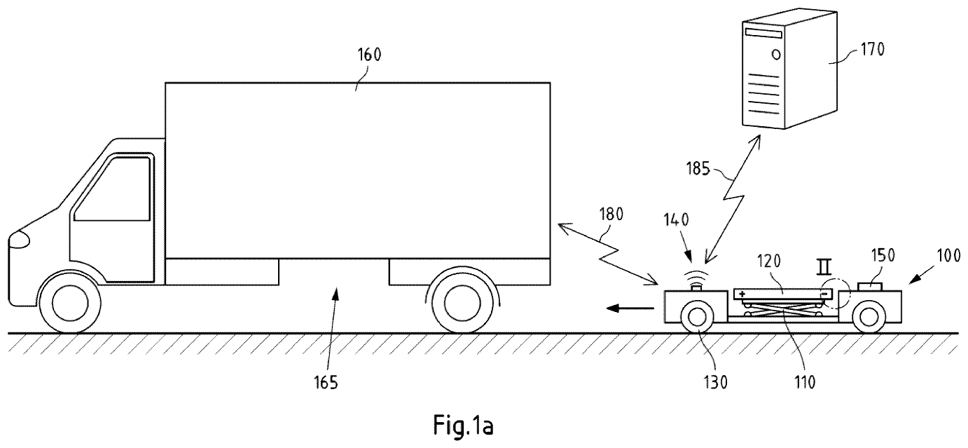

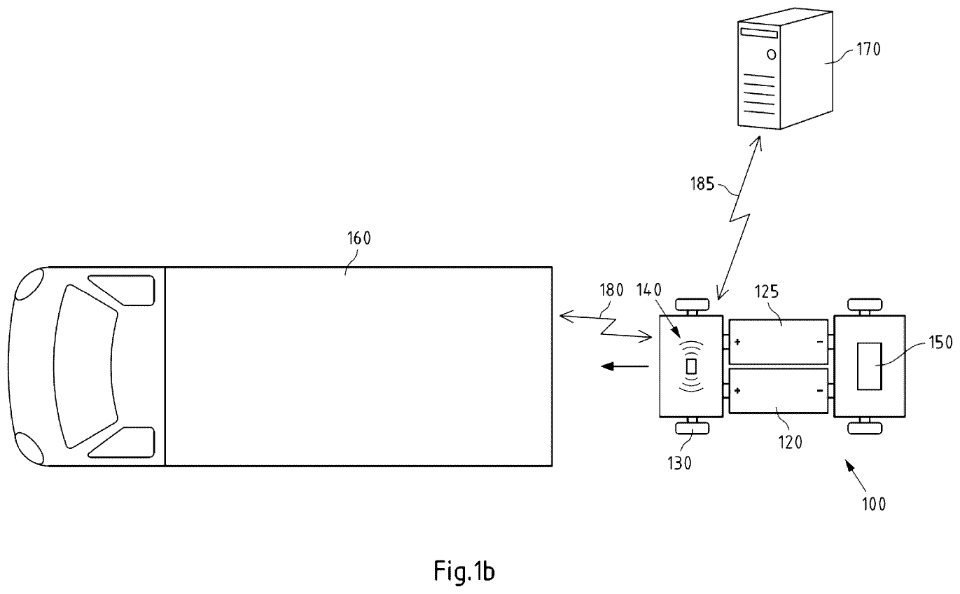

FIG. 1a and FIG. 1b show schematic representations of an illustrative embodiment in accordance with the present disclosure.

FIG. 1a shows, by way of illustration, a mobile changing unit 100 that is navigated to a first position beneath a vehicle 160.

The mobile changing unit 100 is shown as an unmanned transport vehicle (e.g. a mobile robot), the mobile changing unit 100 comprising, inter alia, at least one insertion apparatus 110 with a battery module 120 placed thereon. In addition, the mobile changing unit 100 comprises moving means in the form of multiple wheels 130 and communication means 140 (e.g. an antenna) for wireless radio communication. In particular, the mobile changing unit 100 has a control apparatus 150 that is connected to the other components of the mobile changing unit 100. The control apparatus 150 can accordingly be understood to be an example of the apparatus in accordance with the present disclosure.

The insertion apparatus 110 comprises a lifting mechanism that is configured to raise the platform and the battery module 120 placed thereon. This lifting mechanism is shown as a scissor mechanism by way of illustration, but may also be implemented in another way. Inserting the battery module 120 into the vehicle 160 comprises, for example, inserting the battery module 120 into a battery module compartment 165 in the underbody of the vehicle 160. As part of the insertion or subsequent to the insertion of the battery module into the vehicle 160, the battery module 120 can be, for example, fastened (e.g. fixed) in the vehicle 160 by virtue of the battery module 120 sliding into a retaining apparatus (which e.g. comprises a locking mechanism) of the vehicle 160 and being held there. The battery module 120 to be inserted is a charged battery module, which replaces a previously drained battery module in the vehicle 160. By way of example, a drained battery module of this type is removed from the vehicle 160 before the battery module 120 placed on the insertion apparatus 110 is inserted into the vehicle 160. For this purpose, the mobile changing unit 100 can have at least one removal apparatus (not shown in FIG. 1a), for example.

The vehicle 160 is a vehicle in which one or more battery modules are intended to be replaced. In particular, the battery module 120 transported by the mobile changing unit 100 is intended to be inserted into the vehicle 160, for example in order to replace a previously drained battery module of the vehicle 160. By way of illustration, the vehicle 160 is represented as a truck that is electrically driven at least in part.

The communication means 140 can permit for example wireless communication between the mobile changing unit 100 and the vehicle 160 by providing a wireless communication connection 180 between the mobile changing unit 100 and the vehicle 160. The wireless communication connection 180 is based for example on optical transmission and/or by means of communication that involves electrical, magnetic or electromagnetic signals or fields, in particular short-range communication (e.g. based on Bluetooth or WLAN). For example, the control apparatus 150 uses the communication means 140 to receive vehicle information from the vehicle 160 via the communication connection 180, said vehicle information containing an identifier of the vehicle 160.

Moreover, FIG. 1a shows a backend server 170, which can be understood for example as a management server. For example, the backend server 170 is used to ascertain which battery module is intended to be inserted and/or removed in which vehicle by the mobile changing unit 100 (e.g. from a plurality of mobile changing units). Battery module information transmitted from the backend server 170 to the mobile changing unit 100 accordingly represents for example the battery module 120 that has previously been ascertained by the backend server 170 and that is intended to be inserted into the vehicle 160. Such battery module information can be received via a wireless communication connection 185 on the basis of the communication means 140 of the mobile changing unit 100. By way of example, the communication means 140 then comprise a mobile radio interface that can receive the battery module information and/or vehicle information from the backend server 170 via the wireless communication connection 185.

FIG. 1b shows a plan view of the vehicle 160 presented in FIG. 1a and of the mobile changing unit 100. In this view, it can be seen by way of illustration that the mobile changing unit 100 has two insertion apparatuses beside one another (e.g. at the same height), one battery module 120 being placed on one insertion apparatus and the other battery module 125 being placed on the other insertion apparatus. By way of example, the battery modules 120 and 125 placed on the respective insertion apparatuses are both intended to be inserted into the vehicle 160, whereas in another example they are each intended for a different vehicle, these multiple vehicles being approached by the mobile changing unit 100 in succession in order to insert the applicable battery modules 120 and 125.

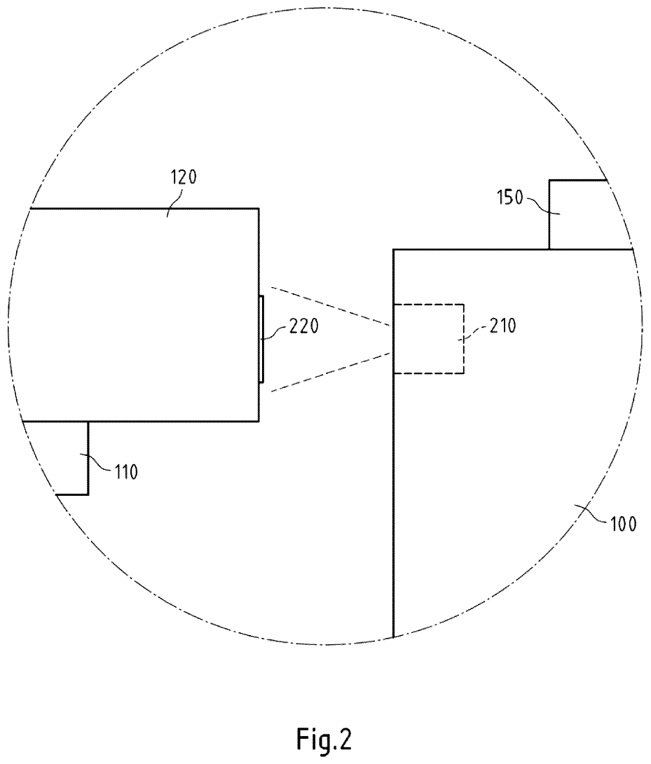

FIG. 2 shows a schematic representation of an illustrative embodiment of sensor means 210 in accordance with the present disclosure. In particular, FIG. 2 shows a detail from FIG. 1 (denoted by “II” in FIG. 1) and, therein, the mobile changing unit 100, the control apparatus 150, the insertion apparatus 110 and the battery module 120 placed on the insertion apparatus 110. Additionally, FIG. 2 shows a code scanner 210 (e.g. an optical sensor such as a camera) as sensor means and a barcode 220 printed on the housing of the battery module 120. By way of example, the code scanner is connected to the control apparatus 150 or can be understood as part of the control apparatus 150. The battery module information represented by the barcode 220 contains an identifier (e.g. a label or an address) that uniquely identifies the battery module 120. The control apparatus 150 can obtain the battery module information represented by the barcode 220 by virtue of the barcode 220 being electronically captured by the code scanner 210 and then forwarded to the control apparatus 150.

As an alternative or in addition to the code scanner 210, the sensor means can also comprise an electronic receiver that receives the battery module information in the form of an electrical signal from the battery module 120 by short-range radio communication (e.g. Bluetooth, NFC or RFID).

FIG. 2 shows, by way of illustration, a single code scanner 220 and a single battery module 120 placed on an insertion apparatus 110. Additionally, the mobile changing unit 100 can comprise multiple insertion apparatuses and multiple code scanners (e.g. a respective code scanner for each insertion apparatus). Such code scanners may each be arranged on or at least close to the respective insertion apparatus of the mobile changing unit 100. For example, each platform of an insertion apparatus on which an applicable battery module may be placed holds a code scanner. Should a battery module be placed on a determined insertion apparatus (as depicted for the battery module 120 in FIG. 2 by way of illustration), the barcode applied to this battery module is scanned by a code scanner arranged on the platform of the insertion apparatus, for example, and is relayed to the control apparatus 150 as battery module information. By way of example, the control apparatus 150 stores (e.g. stored in an electronic memory of the control apparatus 150) which code scanner is arranged on which respective insertion apparatus of the mobile changing unit 100. Since the battery module information is received on the control apparatus 150 from a specific code scanner, the battery module information (e.g. at least implicitly) additionally indicates the insertion apparatus on which the battery module represented by the battery module information is placed.

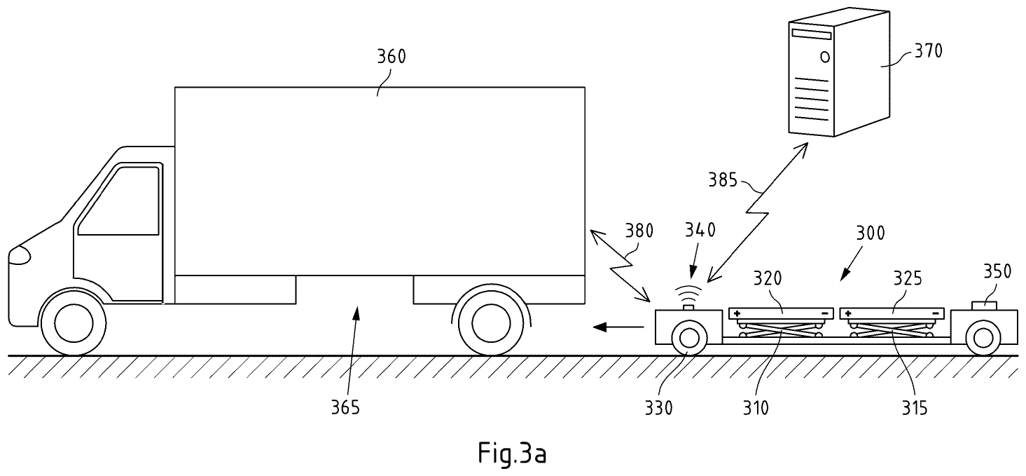

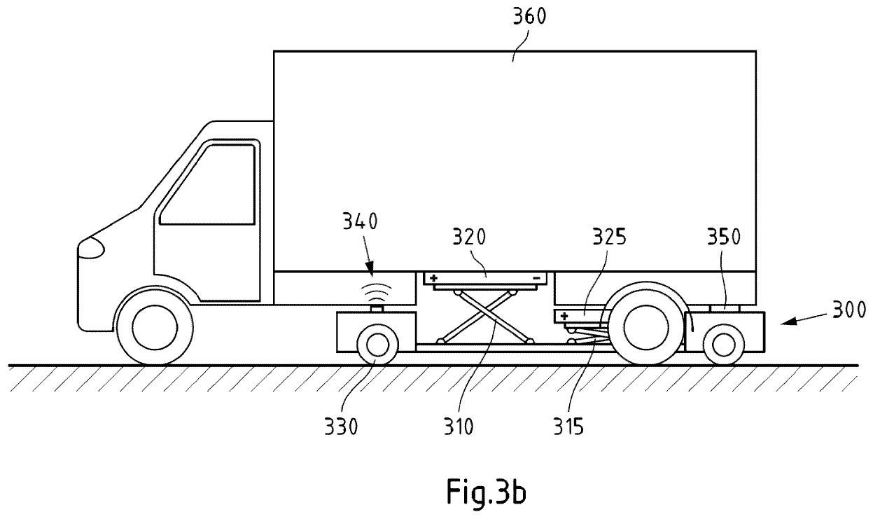

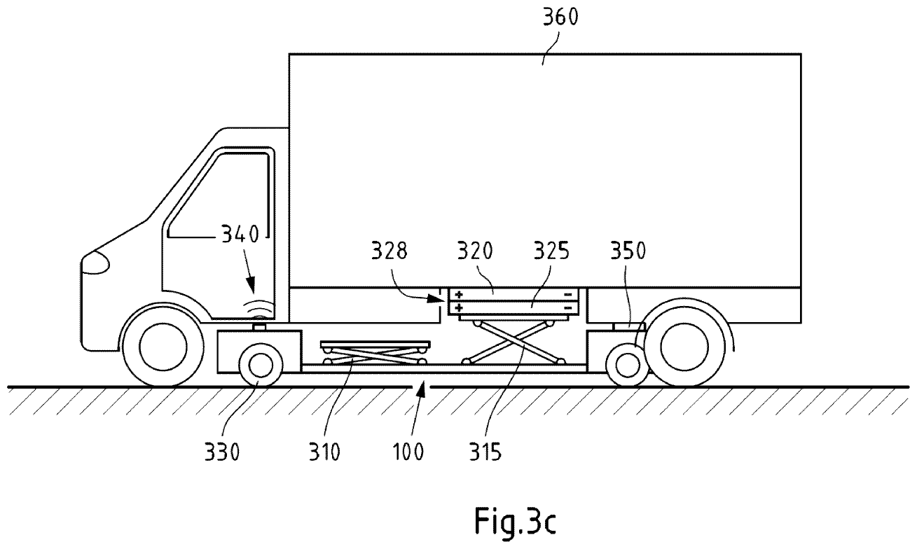

FIGS. 3a, 3b and 3c show schematic representations of a further illustrative embodiment in accordance with the present disclosure.

FIG. 3a shows, similarly to FIG. 1a, a mobile changing unit 300 as an unmanned transport vehicle (e.g. a mobile robot), the mobile changing unit 300 comprising an insertion apparatus 310 having a battery module 320 placed thereon and additionally a further insertion apparatus 315 having a further battery module 325 placed thereon. In addition, the mobile changing unit 300 comprises moving means in the form of multiple wheels 330 and communication means 340 (e.g. an antenna) for wireless radio communication. In particular, the mobile changing unit has a control apparatus 350 that is connected to the other components of the mobile changing unit 300. The control apparatus 350 can accordingly be understood to be an example of the apparatus in accordance with the present disclosure.

FIG. 3a shows, by way of illustration, the mobile changing unit 300, which is being navigated to a first position beneath a vehicle 360 by the control apparatus 350. FIG. 3b shows the mobile changing unit 300 at a later time than in FIG. 3a, the mobile changing unit 300 in accordance with FIG. 3b being in the first position beneath the vehicle 360 while the battery module 320 is inserted into the vehicle 360 using the insertion apparatus 310. FIG. 3c shows the mobile changing unit 300 at a later time than in FIG. 3b, the mobile changing unit 300 in accordance with FIG. 3b being in a second position beneath the vehicle 360 while the further battery module 325 is inserted into the vehicle 360 using the further insertion apparatus 315.

After the battery module 320 is inserted as shown in FIG. 3b, the mobile changing unit 300 can accordingly be navigated to a second position beneath the vehicle 360 before, as shown in FIG. 3c, the further battery module 325 is inserted into the vehicle 360. The first position is chosen in this case such that the insertion apparatus 310 is under the battery module compartment 365 in the underbody of the vehicle 360. The second position is chosen such that the insertion apparatus 315 is under the battery module compartment 365 in the underbody of the vehicle 360. If the mobile changing unit 300 is accordingly in the second position (see FIG. 3c), the further battery module 325 placed on the further insertion apparatus 315 can be inserted into the battery module compartment 365 by raising the platform of the insertion apparatus 315, and so the further battery module 325 is inserted inside the battery module compartment 365 beneath the previously inserted battery module 320.

Advantageously, navigating the mobile changing unit 300 from the first to the second position allows the two battery modules 320 and 325 to be inserted into the vehicle 360 in such a way that they are arranged beneath one another in the form of a battery stack 328 inside the battery module compartment 365 of the vehicle 360. The battery modules 320 and 325 arranged above one another in such a way are advantageously on different insertion apparatuses 310 and 315 while being transported by the mobile changing unit 300, however, which means that the total height of the loaded mobile changing unit 300 is reduced and movement beneath the vehicle 360 is permitted.

Within the battery stack 328, the battery modules 320 and 325 arranged beneath one another are electrically connected to one another as a result of being electrically connected to one another in series or parallel (e.g. to achieve a desired voltage or electrical capacitance), for example. An electrical connection between the two battery modules 320 and 325 can be achieved for example by way of additional connecting structures of the battery modules.

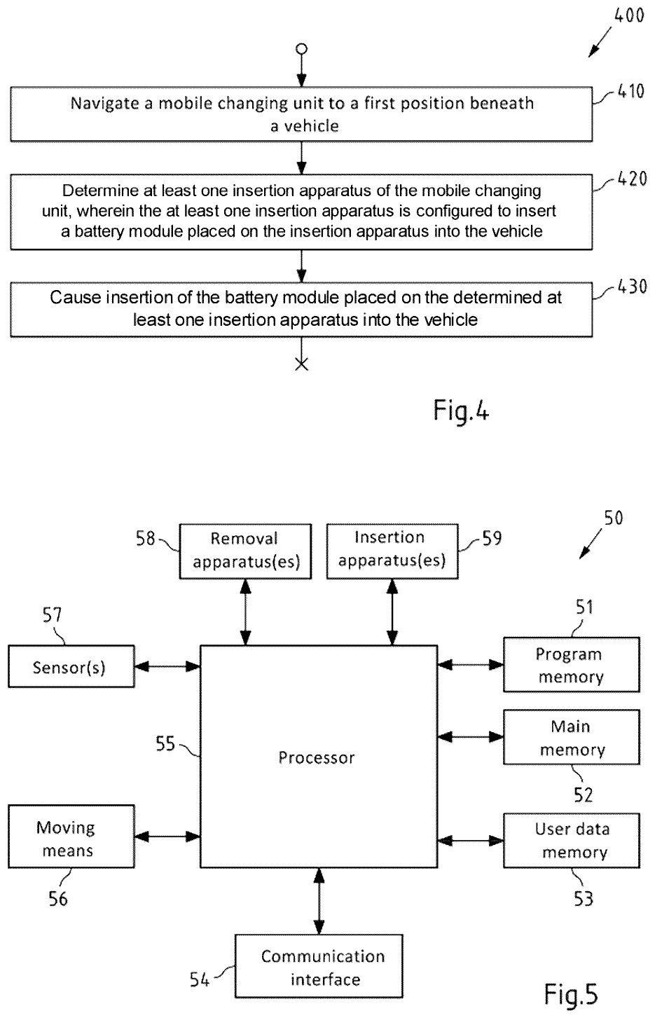

FIG. 4 shows a flowchart for an illustrative embodiment of a method 400 in accordance with the present disclosure. Method steps 410, 420 and 430 of the method 400 are described by way of illustration below with reference to the illustrative embodiment shown in FIGS. 1a and 1n FIG. 1b. It is assumed by way of illustration that method steps 410, 420 and 430 are performed by the control apparatus 150 of the mobile changing unit 100.

Step 410 comprises navigating a mobile changing unit to a first position beneath a vehicle.

For example, the control apparatus 150 actuates the moving means 130 of the mobile changing unit 100 in such a way that the mobile changing unit 100 moves from its present position to the first position. The mobile changing unit 100 moves to the first position in an at least partially autonomously driving manner, the control apparatus 150 using for example sensors such as cameras, ultrasonic sensors or infrared sensors to detect and avoid obstacles on the way to the first position. Alternatively or additionally, the mobile changing unit 100 can use positioning sensors (e.g. one or more GPS sensors) to navigate the mobile changing unit 100 to the first position.

Step 420 comprises determining at least one insertion apparatus of the mobile changing unit, wherein the at least one insertion apparatus is configured to insert a battery module placed on the insertion apparatus into the vehicle.

For example, the control apparatus 150 determines the insertion apparatus 110 of the mobile changing unit 100 by virtue of the control apparatus 150 selecting the insertion apparatus 110. By way of illustration, the mobile changing unit 100 comprises two insertion apparatuses that are arranged beside one another, determination of an insertion apparatus comprising selection of the insertion apparatus 110. By way of example, the insertion apparatus 100 is selected in a predetermined order. In another example, the insertion apparatus 110 is determined according to the battery module 120 placed on the insertion apparatus 110. By way of example, information that denotes the battery module 120 to be inserted into the vehicle 160 is taken as a basis for determining the corresponding insertion apparatus 110 on which the denoted battery module 120 is placed. For this purpose, an electronic memory of the control apparatus 150 stores, for example, information about which respective battery module is placed on which insertion apparatus of the two insertion apparatuses of the mobile changing unit.

In another example, determination of the insertion apparatus 110 in step 420 can be based on battery module information that identifies the battery module 120.

By way of example, such battery module information can indicate which battery module is placed on which insertion apparatus of the mobile changing unit 100. For example, the code scanner 210 of the mobile changing unit 100 (see FIG. 2) scans the barcode 220 printed on the housing of the battery module 120, the barcode 220 representing battery module information that contains an identifier of the battery module 120. The battery module information captured by the code scanner 210 is then transmitted to the control apparatus 150. The control apparatus 150 stores information indicating that the code scanner 210 is arranged on the platform of the insertion apparatus 110, and so the battery module information relayed from the code scanner 210 to the control apparatus 150 (e.g. at least implicitly) additionally indicates that the battery module 120 represented by the battery module information is placed on the insertion apparatus 110. By way of example, the control apparatus 150 stores information according to which the battery module 120 is intended to be inserted into the vehicle 160. Accordingly, step 420 comprises determining the insertion apparatus 110 on the basis of the battery module information revealing that the battery module 120 to be inserted into the vehicle 160 is placed on the insertion apparatus 110.

By way of example, battery module information can additionally identify a battery module that is intended to be inserted into the vehicle 160. As shown in FIG. 1b, the mobile changing unit 100 has two insertion apparatuses on which respective battery modules 120 and 125 are placed. Obtained battery module information then represents, for example, the battery module 120 that is intended to be inserted into the vehicle 160. In such an example, the battery module 125 placed on the other insertion apparatus may be intended for another vehicle, for example, and therefore inserted into this other vehicle at a later time. Determination in step 420 is then based at least in part on the obtained battery module information. If for example the battery module information represents the battery module 120 that is intended to be inserted into the vehicle 160, the insertion apparatus 110 on which the battery module 120 represented by the battery module information is placed is determined on the basis of the battery module information. In such an example, determination of the insertion apparatus may additionally be based on information (e.g. stored in an electronic memory of the control apparatus 150) that indicates for the two insertion apparatuses of the mobile changing unit 100 which battery module, if any, is placed on the respective insertion apparatus. For example, the battery module information is received by communication means 140 from the backend server 170 via a mobile radio network, the backend server 170 being able to be understood to mean a management server that is used to ascertain in which vehicle which battery module is intended to be inserted and/or removed by the mobile changing unit 100 (e.g. from a plurality of mobile changing units). Battery module information transmitted from the backend server 170 to the control apparatus 150 accordingly represents the battery module 120 that has previously been ascertained by the backend server 170 and that is intended to be inserted into the vehicle 160.

In another example, determination of the insertion apparatus 110 in step 420 can be based on vehicle information, the vehicle information denoting, for example, the vehicle 160 that the mobile changing unit 100 in the first position is under and into which the battery module 120 placed on the insertion apparatus 110 of the mobile changing unit 100 is intended to be inserted. By way of example, the vehicle information can be obtained at the control apparatus 150 from the backend server 170 via a mobile radio network (e.g. via the communication connection 185) or from the vehicle 160 by short-range radio communication (e.g. Bluetooth, NFC or RFID via the communication connection 180).

Step 430 comprises causing insertion of the battery module placed on the determined at least one insertion apparatus into the vehicle.

For example, the control apparatus 150 actuates the insertion apparatus 110 determined in step 420 so that a lifting mechanism of the insertion apparatus 110 is activated and thus this lifting mechanism is caused to raise the battery module 120 placed on the platform of the insertion apparatus 110 and to insert said battery module into the vehicle 160. In one example, in which more than one insertion apparatus of the mobile changing unit 100 has been determined in the previous step 420, step 430 comprises for example each of the determined insertion apparatuses in succession being caused to insert the battery module placed on the respective insertion apparatus into the vehicle.

FIG. 5 shows a schematic representation of an illustrative embodiment of the apparatus 50 in accordance with the present disclosure. By way of example, the apparatus 50 can be understood to be the control apparatus 150 of the mobile changing unit 100 shown in FIG. 1a and FIG. 1b or to be the control apparatus 350 of the mobile changing unit 300 shown in FIGS. 3a to 3c.

By way of illustration, the control apparatus 50 comprises a processor 55. A processor is intended to be understood to mean for example a microprocessor, a microcontrol unit, a microcontroller, a digital signal processor (DSP), an application-specific integrated circuit (ASIC) or a field programmable gate array (FPGA). It goes without saying that the control apparatus 50 can also comprise multiple processors 55.

The processor 55 executes program instructions stored in the program memory 51, and stores, for example, intermediate results or the like in the main memory 52. By way of example, the program memory 51 contains program instructions of a computer program in accordance with the present disclosure that comprises program instructions that prompt the processor 55 to perform and/or control the method in accordance with the present disclosure (e.g. the method 400 in accordance with FIG. 4) when the processor 55 executes the program instructions stored in the program memory 51.

The program memory 51 further contains, for example, an operating system of the control apparatus 50, at least part of which is loaded into the main memory 52 and executed by the processor 55 when the control apparatus 50 starts. In particular, at least part of the core of the operating system is loaded into the main memory 52 and executed by the processor 55 when the control apparatus 50 starts.

An example of an operating system is a Windows, UNIX, Linux, Android, Apple iOS and/or MAC OS operating system. The operating system permits in particular the use of the control apparatus 50 for data processing. By way of example, it manages resources such as the program memory 51 and the main memory 52 and uses programming interfaces, inter alia, to provide other computer programs with basic functions and controls the execution of computer programs.

A program memory is, for example, a nonvolatile memory such as a flash memory, a magnetic memory, an EEPROM (electrically erasable programmable read-only memory) and/or an optical memory. A main memory is, for example, a volatile or nonvolatile memory, in particular a random access memory (RAM) such as a static RAM (SRAM) memory, a dynamic RAM (DRAM) memory, a ferroelectric RAM (FeRAM) memory and/or a magnetic RAM (MRAM) memory.

The user data memory 53 is used for storing data that are required for executing the program. In the present case, these may be battery module information and/or vehicle information, for example.

Moreover, the control apparatus 50 may be connected to a communication interface 54 of the mobile changing unit 100 (e.g. the communication means 140 shown in FIG. 1a and FIG. 1b). By way of example, the communication interface 54 comprises a mobile radio interface (e.g. for receiving battery module information or vehicle information from the backend server 170) and/or a short-range radio communication interface (e.g. Bluetooth, NFC or RFID for receiving battery module information from a battery module or for receiving vehicle information from a vehicle).

Moreover, the control apparatus 50 is connected for example to one or more sensors 57. By way of example, the sensor 57 can comprise a code scanner (e.g. an optical sensor such as a camera) that can scan an optically capturable code. In another example, the sensors 57 can comprise an electronic receiver that can receive battery module information in the form of an electrical signal from the battery module by short-range radio communication (e.g. Bluetooth, NFC or RFID).

The control apparatus 50 is additionally connected to moving means 56, these being able to be the wheels 130 of the mobile changing unit 100 and a steering mechanism of these wheels, for example. The control apparatus 50 can actuate these moving means 56 in order to move the mobile changing unit 100 and for example to navigate said mobile changing unit to a first position beneath the vehicle 160.

The control apparatus 50 is additionally connected to at least one removal apparatus 58 and at least one insertion apparatus 59. By way of example, the control apparatus 50 can actuate the insertion apparatus 59 (e.g. the insertion apparatus 110 in FIG. 1a) so that a lifting mechanism of this determined insertion apparatus 59 is activated and this lifting mechanism is thus caused to raise the battery module placed on a platform of the insertion apparatus 59.

As described above, the communication interface 54, the moving means 56, the sensors 57 and/or the removal and insertion apparatuses 58, 59 may be connected to the control apparatus 50, and so they can be controlled by the control apparatus 50, for example, and can relay information to the control apparatus. In other examples, the communication interface 54, the moving means 56, the sensors 57 and/or the removal and insertion apparatuses 58, 59 can additionally be understood to be part of the control apparatus 50.

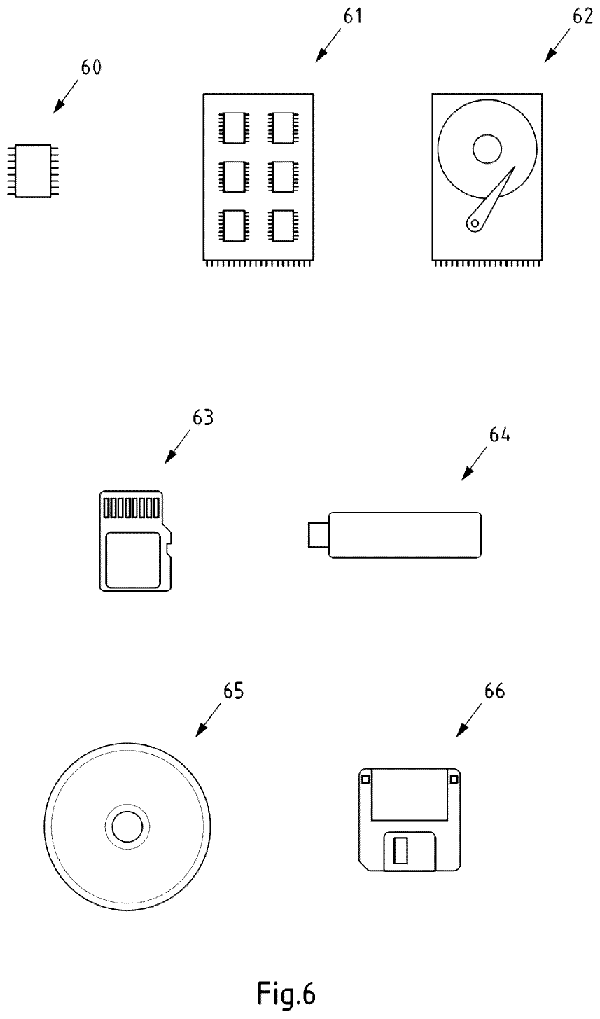

FIG. 6 shows illustrative embodiments of storage media on which for example a computer program in accordance with the present disclosure may be stored. The storage medium may be for example a magnetic, electrical, optical and/or other type of storage medium. The storage medium may be for example part of a processor (e.g. the processor 55 in FIG. 5), for example a (nonvolatile or volatile) program memory of the processor or a part thereof (e.g. program memory 51 in FIG. 5). Exemplary embodiments of a storage medium are a flash memory 60, an SSD hard disk 61, a magnetic hard disk 62, a memory card 63, a memory stick 65 (e.g. a USB stick), a CD-ROM or DVD 65 or a floppy disk 66.

The illustrative embodiments of the present disclosure that are described in this specification should also be understood as disclosed in all combinations with one another. In particular, the description of a feature that an embodiment comprises should also not-unless explicitly stated to the contrary—be understood in the present case to mean that the feature is indispensable or essential for the function of the exemplary embodiment. The sequence of the method steps outlined in this disclosure in the individual flowcharts is not mandatory; alternative sequences of the method steps are conceivable—unless indicated otherwise. The method steps may be implemented in various ways, and so implementation using software (by means of program instructions), hardware or a combination of the two is conceivable for implementing the method steps.

Terms used in the patent claims such as “comprise”, “have”, “include”, “contain” and the like do not exclude further elements or steps. The wording “at least in part” encompasses both the “in part” case and the “in full” case. The wording “and/or” should be understood to the effect that both the alternative and the combination are intended to be disclosed, that is to say that “A and/or B” means “(A) or (B) or (A and B)”. In the context of this specification, a plurality of units, persons or the like means multiple units, persons or the like. The use of the indefinite article does not exclude a plurality. A single device may perform the functions of a plurality of units or devices mentioned in the patent claims. Reference signs indicated in the patent claims should not be regarded as limitations for the means and steps used. The following exemplary embodiments are disclosed as part of the present disclosure:

### Exemplary Embodiment 1

Apparatus, comprising means configured to:
navigate a mobile changing unit to a first position beneath a vehicle;
determine at least one insertion apparatus of the mobile changing unit, wherein the at least one insertion apparatus is configured to insert a battery module placed on the insertion apparatus into the vehicle; and
cause insertion of the battery module placed on the determined at least one insertion apparatus into the vehicle.

### Exemplary Embodiment 2

Apparatus according to embodiment 1, wherein the mobile changing unit comprises a plurality of insertion apparatuses including the at least one insertion apparatus, wherein each of the insertion apparatuses is configured to insert a battery module placed on the respective insertion apparatus, and wherein the means of the apparatus are further configured to:
determine at least one further insertion apparatus from the plurality of insertion apparatuses; and
cause insertion of a further battery module placed on the determined at least one further insertion apparatus into the vehicle.

### Exemplary Embodiment 3

Apparatus according to embodiment 2, wherein the means of the apparatus are further configured to:
navigate the mobile changing unit, after the at least one battery module has been inserted into the vehicle and before the at least one further battery module is inserted into the vehicle, from the first position to a second position beneath the vehicle.

### Exemplary Embodiment 4

Apparatus according to embodiment 1, wherein the means of the apparatus are further configured to:
cause, after the at least one battery module has been inserted, insertion of at least one further battery module placed on the determined at least one insertion apparatus into the vehicle.

### Exemplary Embodiment 5

Apparatus according to one of the embodiments 1 to 4, wherein the at least one insertion apparatus and/or the plurality of insertion apparatuses of the mobile changing unit are configured to insert the at least one battery module and the at least one further battery module into the vehicle in such a way that the at least one battery module and the at least one further battery module form a single battery stack inside the vehicle.

### Exemplary Embodiment 6

Apparatus according to embodiment 5, wherein the at least one battery module and the at least one further battery module are arranged beneath one another and/ore are electrically connected to one another within the battery stack.

### Exemplary Embodiment 7

Apparatus according to one of the embodiments 1 to 6, wherein the means are further configured to:
cause removal of a battery module from the vehicle before the at least one and/or the at least one further battery module is inserted into the vehicle, wherein the mobile changing unit comprises at least one removal apparatus for removing a battery module from the vehicle.

### Exemplary Embodiment 8

Apparatus according to one of the embodiments 1 to 7, wherein the means are further configured to:
obtain at least one battery module information, wherein the battery module information represents a battery module, and wherein determining the at least one insertion apparatus is at least partially based on the obtained battery module information.

### Exemplary Embodiment 9

Apparatus according to embodiment 8, the apparatus further comprising sensor means configured to obtain the battery module information from the battery module represented by the battery module information.

### Exemplary Embodiment 10

Apparatus according to embodiment 8, the apparatus further comprising communication means configured to receive the battery module information from a backend server.

### Exemplary Embodiment 11

Apparatus according to one of the embodiments 1 to 10, wherein the means are further configured to:
obtain vehicle information, wherein the vehicle information represents the vehicle, and wherein determining the at least one insertion apparatus is at least partially based on the obtained vehicle information.

### Exemplary Embodiment 12

Apparatus according to one of the embodiments 1 to 11, the apparatus further comprising communication means configured to receive the vehicle information from the vehicle or from a backend server.

### Exemplary Embodiment 13

Apparatus according to one of the embodiments 1 to 12, wherein the apparatus further comprises:
moving means for moving the mobile changing unit comprising a motor drive and/or a plurality of wheels; and/or
the at least one insertion apparatus; and/or the at least one removal apparatus; and/or
communication means for communicating with the backend server and/or the vehicle.

### Exemplary Embodiment 14

Method comprising:
navigating a mobile changing unit to a first position beneath a vehicle;
determining at least one insertion apparatus of the mobile changing unit, wherein the at least one insertion apparatus is configured to insert a battery module placed on the insertion apparatus into the vehicle; and
causing insertion of the battery module placed on the determined at least one insertion apparatus into the vehicle.

### Exemplary Embodiment 15

Computer program, comprising commands that cause an apparatus to perform the method steps according to embodiment 14.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus comprising means configured to:
navigate a mobile changing unit to a first position beneath a vehicle;
determine at least one insertion apparatus of the mobile changing unit, wherein the at least one insertion apparatus is configured to insert a battery module placed on the insertion apparatus into the vehicle; and
cause insertion of the battery module placed on the determined at least one insertion apparatus into the vehicle,
wherein the apparatus is part of the mobile changing unit, wherein the means are further configured to:
obtain vehicle information, wherein the vehicle information represents the vehicle, and wherein determining the at least one insertion apparatus is at least partially based on the obtained vehicle information.

2. The apparatus according to claim 1, wherein the mobile changing unit comprises a plurality of insertion apparatuses including the at least one insertion apparatus, wherein each of the insertion apparatuses is configured to insert a battery module placed on the respective insertion apparatus, and wherein the means of the apparatus are further configured to:
determine at least one further insertion apparatus from the plurality of insertion-apparatuses; and
cause insertion of a further battery module placed on the determined at least one further insertion apparatus into the vehicle.

3. The apparatus according to claim 2, wherein the means of the apparatus are further configured to:
navigate the mobile changing unit, after the at least one battery module has been inserted into the vehicle and before the at least one further battery module is inserted into the vehicle, from the first position to a second position beneath the vehicle.

4. The apparatus according to claim 1, wherein the means of the apparatus are further configured to:
cause, after the at least one battery module has been inserted, insertion of at least one further battery module placed on the determined at least one insertion apparatus into the vehicle.

5. The apparatus according to claim 1, wherein the at least one insertion apparatus and/or the plurality of insertion apparatuses of the mobile changing unit are configured to insert the at least one battery module and the at least one further battery module into the vehicle in such a way that the at least one battery module and the at least one further battery module form a single battery stack inside the vehicle.

6. The apparatus according to claim 5, wherein the at least one battery module and the at least one further battery module are arranged beneath one another and/or are electrically connected to one another within the battery stack.

7. The apparatus according to claim 1, wherein the means are further configured to:
cause removal of a battery module from the vehicle before the at least one and/or the at least one further battery module is inserted into the vehicle, wherein the mobile changing unit comprises at least one removal apparatus for removing a battery module from the vehicle.

8. The apparatus according to claim 1, wherein the means are further configured to:
obtain at least one battery module information, wherein the battery module information represents a battery module, and wherein determining the at least one insertion apparatus is at least partially based on the obtained battery module information.

9. The apparatus according to claim 8, the apparatus further comprising sensor means configured to obtain the battery module information from the battery module represented by the battery module information.

10. The apparatus according to claim 8, the apparatus further comprising communication means configured to receive the battery module information from a backend server.

11. The apparatus according to claim 1, the apparatus (150;350;50) further comprising communication means configured to receive the vehicle information from the vehicle or from a backend server.

12. The apparatus according to claim 1, wherein the apparatus further comprises:
moving means for moving the mobile changing unit comprising a motor drive and/or a plurality of wheels; and/or
the at least one insertion apparatus; and/or
the at least one removal apparatus; and/or
communication means for communicating with the backend server and/or the vehicle.

13. A method, performed by an apparatus, which is part of a mobile changing unit, wherein the method comprises:
navigating the mobile changing unit to a first position beneath a vehicle;
determining at least one insertion apparatus of the mobile changing unit (100;300), wherein the at least one insertion apparatus is configured to insert a battery module (120;320) placed on the insertion apparatus into the vehicle; and
causing insertion of the battery module placed on the determined at least one insertion apparatus into the vehicle, wherein the method further comprises:
obtaining vehicle information, the vehicle information representing the vehicle, and wherein determining the at least one insertion apparatus is at least partially based on the obtained vehicle information.

14. A computer program, comprising commands that cause an apparatus to perform the method steps according to claim 13.
